(19) United States
(12) Patent Application Publication
(10) Pub. No.: US 2013/0104685 A1
(43) Pub. Date: May 2, 2013

(54) ROBOT ARM ASSEMBLY

(71) Applicant: BO LONG, Shenzhen City (CN)

(72) Inventor: BO LONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/537,325

(22) Filed: Jun. 29, 2012

(30) Foreign Application Priority Data
Oct. 31, 2011 (CN) 201110337327.4

(51) Int. Cl. B25J 18/00

(52) U.S. Cl. 74/490.03; 74/490.01; 901/25; 901/23

(57) ABSTRACT

A robot arm assembly includes a receiving box, a hollow tube, a first output shaft, and a first driving mechanism. The receiving box defines an assembling hole and a through hole. The hollow tube is assembled within the receiving box with two ends of the hollow tube aligning with the assembling hole and the through hole, respectively. The first output shaft is hollow, and rotatably assembled to the receiving box. The first output shaft is coaxial with the assembling hole of the receiving box and defines a cable passage cooperatively with hollow tube. The first driving mechanism is assembled within the receiving box and is connected with the first output shaft, to drive the first output shaft to rotate relative to the receiving box.

### BACKGROUND

1. Technical Field

This disclosure relates to robotics, and particularly, to a robot arm assembly for a spraying robot.

2. Description of Related Art

A commonly used spraying robot includes a plurality of individual robot arms, with every two robot arms rotatably connected together by a joint structure. The spraying robot further includes a spraying mechanism mounted to a distal end of the spraying robot. The robot arms are driven to rotate by electric motors mounted outside of the robot arms, in addition, the spraying mechanism is also electrically connected with electric power by electric cables. In use, the electric motors and electric cables are generally exposed to the outside and contact with the liquid spraying material, thus, the electric cables and the electric motors are easy to be contaminated. Meanwhile, the dusty spraying material is easy to be adhered to the electric cables and the electric motors.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 shows an isometric view of an embodiment of a robot arm assembly.

FIG. 2 shows a partially exploded isometric view of the robot arm assembly of FIG. 1.

FIG. 3 shows a cross-sectional view of the robot arm assembly of FIG. 1 taken along line III-III.

### DETAILED DESCRIPTION

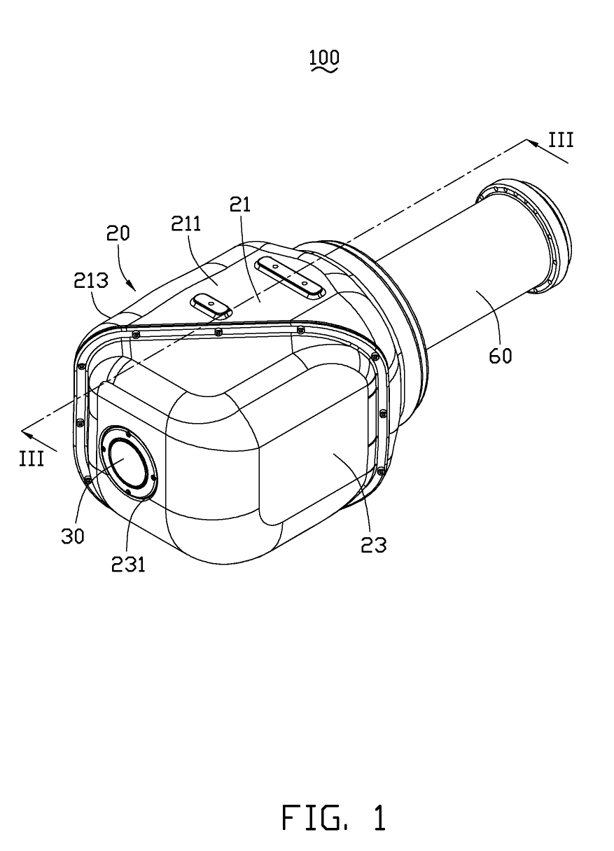

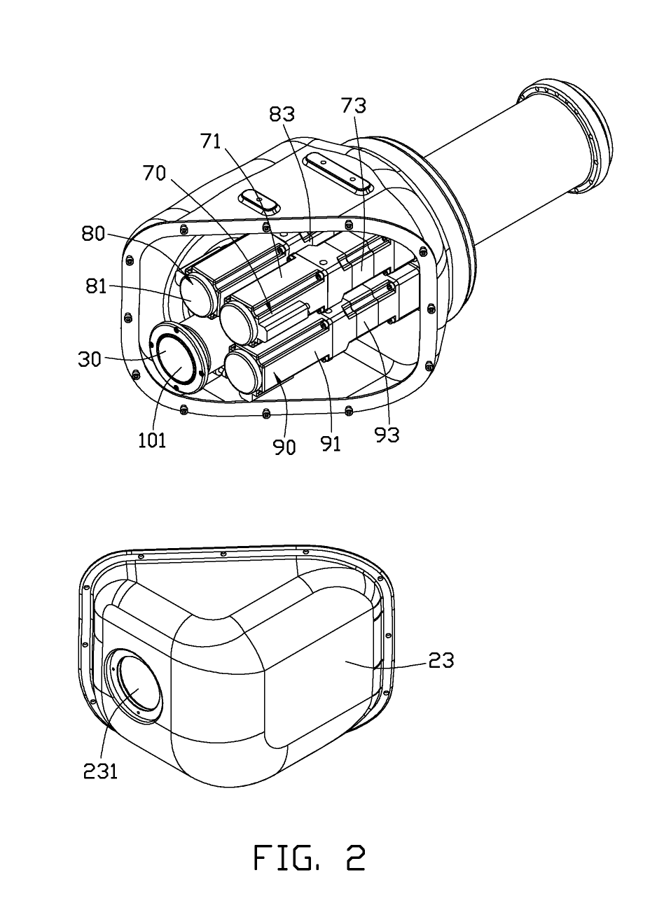

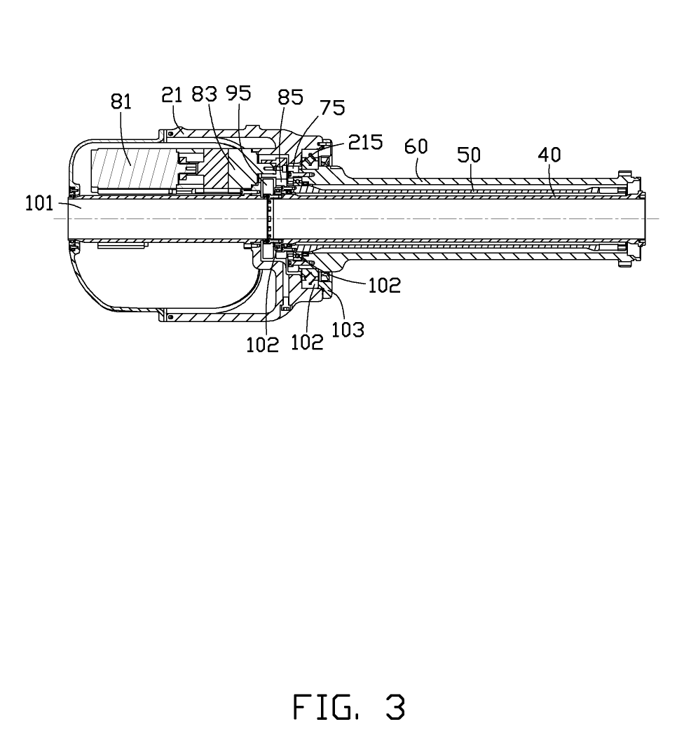

FIGS. 1 through 3, illustrate an embodiment of a robot arm assembly 100. The robot arm assembly 100 includes a receiving box 20, a hollow tube 30, a first output shaft 40, a second output shaft 50, a third output shaft 60, a first driving mechanism 70, a second driving mechanism 80 and a third driving mechanism 90. The hollow tube 30 is assembled within the receiving box 20 with a first end passing through a corresponding first end of the receiving box 20. The first output shaft 40 is rotatably assembled to an opposite second end of the receiving box 20, and is coaxial with the hollow tube 30. The second output shaft 50 is rotatably sleeved on the first output shaft 40 and assembled to the receiving box 20. The third output shaft 60 is rotatably sleeved on the second output shaft 50 and assembled to the receiving box 20. Such that, the second output shaft 50 is rotatably located and sandwiched between the first output shaft 40 and the third output shaft 60. The first driving mechanism 70, the second driving mechanism 80 and the third driving mechanism 90 are all assembled within the receiving box 20 for driving corresponding first output shaft 40, the second output shaft 50, and the third output shaft 60 to rotate relative to the receiving box 20. In the illustrated embodiment, the first driving mechanism 70, the second driving mechanism 80 and the third driving mechanism 90 are located along a peripheral direction of an outer peripheral surface of the hollow tube 30.

The receiving box 20 is a substantially hollow rectangular box in the illustrated embodiment. The receiving box 20 includes a receiving body 21 and a cover body 23 detachably mounted to the receiving body 21. The receiving body 21 and the cover body 23 are both half rectangular shaped which are formed by cutting from a diagonal line of a hollow rectangular body. The receiving body 21 includes two parallel triangular first side surfaces 211, and two rectangular second side surfaces 213 respectively connecting with two adjacent edges of the two first side surfaces 211. The two first side surfaces 211 and the two second side surfaces 213 cooperatively define a substantially hollow triangular shaped receiving space (not labeled). One second side surface 213 defines an assembling hole 215. The cover body 23 has substantially same shape as that of the receiving body 21. The cover body 23 defines a though hole 231 opposite to and coaxial with the assembling hole 215 of the receiving body 21. The cover body 23 and the receiving body 21 cooperatively form the substantially rectangular receiving box 20 and define a substantially rectangular inner receiving space.

The hollow tube 30 is substantially hollow cylindrical, and is assembled within the receiving box 20. A first end of the hollow tube 30 is aligned with the through hole 231 of the cover body 23 and is coaxially received within the through hole 231, an opposite second end of the hollow tube 30 is aligned with the opposite assembling hole 215 of the receiving body 21.

The first output shaft 40, the second output shaft 50 and the third output shaft 60 are all hollow cylindrical, coaxially sleeved together in that order, and are respectively rotatably assembled to the assembling hole 215 of the receiving body 21. The first output shaft 40 is coaxial with the hollow tube 30 and cooperative defines a coaxial passage 101 with the hollow tube 30, for facilitating electric cables (not shown), air pipes (not shown) and the like passing through.

The first driving mechanism 70 includes a first driving motor 71, a first speed reducer 73, and a first driving gear 75. The first driving gear 75 is assembled within the assembling hole 215 of the receiving body 21 and fixed with the first output shaft 40. In the illustrated embodiment, the first driving gear 75 is a hollow driving gear coaxially fixed with one end of the first output shaft 40. The first driving motor 71 is fixed within the receiving body 21 and connected with the corresponding first driving gear 75, for driving the first driving gear 75 to rotate. The first speed reducer 73 is received within the receiving body 21 and assembled with the first driving motor 71 for controlling a speed of the first driving motor 71.

The second driving mechanism 80 includes a second driving motor 81, a second speed reducer 83, and a second driving gear 85. The second driving gear 85 is also assembled within the assembling hole 215 of the receiving body 21 and fixed with one end of the second output shaft 50. In the illustrated embodiment, the second driving gear 85 is a hollow driving gear coaxially fixed with the second output shaft 50. The second driving motor 81 is fixed within the receiving body 21 and connected with the second driving gear 85, for driving the second driving gear 85 to rotate. The second speed reducer 83 is received within the receiving body 21 and assembled with the second driving motor 81 for controlling a speed of the second driving motor 81.

The third driving mechanism 90 includes a third driving motor 91, a third speed reducer 93, and a third driving gear 95. The third driving gear 95 is assembled within the assembling hole 215 of the receiving body 21 and fixed with one end of the third output shaft 60. In the illustrated embodiment, the third driving gear 95 is a hollow driving gear coaxially fixed with the third output shaft 60. The third driving motor 91 is fixed within the receiving body 21 and connected with the third driving gear 95, for driving the third driving gear 95 to rotate. The third speed reducer 93 is received within the receiving body 21 and is assembled with the third driving motor 91 for controlling a speed of the third driving motor 91.

In one embodiment, in order to ensure a perfect rotation between the first output shaft 40 and the receiving box 20, the first output shaft 40 is rotatably assembled with the assembling hole 215 of the receiving body 21 by a rolling bearing 102. In the same way, the second output shaft 50 may be rotatably sleeved with the first output shaft 40 by the rolling bearing 102, the third output shaft 60 also may be rotatably sleeved with the second output shaft 50 via the rolling bearing 102.

In one embodiment, the third output shaft 60 is hermetically assembled with assembling hole 215 of the receiving body 21 by a sealing ring 103.

The number of the output shafts and the driving mechanisms is not limited to three of the illustrated embodiment, the number of the output shafts and the driving mechanisms depends on actual needs. Namely, the robot arm assembly 100 may include at least one output shaft and at least one driving mechanism.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A robot arm assembly comprising:
a receiving box defining an assembling hole and a through hole;
a hollow tube assembled within the receiving box, two ends of the hollow tube aligning with the assembling hole and the through hole, respectively;
a first output shaft rotatably assembled to the receiving box, and being coaxial with the assembling hole of the receiving box; and
a first driving mechanism assembled within the receiving box and connected with the first output shaft, thereby driving the first output shaft to rotate relative to the receiving box;
wherein, the first output shaft is hollow, the first output shaft and the hollow tube cooperatively define a cable passage for facilitating electric cables passing through.

2. The robot arm assembly of claim 1, wherein the first driving mechanism comprises a first driving motor, a first speed reducer, and a first driving gear, the first driving gear is assembled within the assembling hole of the receiving box and fixed with the first output shaft, the first driving motor is fixed within the receiving box and connected with the first driving gear, for driving the first driving gear to rotate, and the first speed reducer is assembled with the first driving motor for controlling a speed of the first driving motor.

3. The robot arm assembly of claim 2, wherein the first driving gear is a hollow driving gear coaxially fixed with one end of the first output shaft.

4. The robot arm assembly of claim 2 further comprising a second output shaft and a second driving mechanism, wherein the second output shaft is hollow and rotatably sleeved on the first output shaft, the second driving mechanism is assembled within the receiving box and connected with the second output shaft thereby driving the second output shaft to rotate.

5. The robot arm assembly of claim 4 further comprising a third output shaft and a third driving mechanism, wherein the third output shaft is hollow and rotatably sleeved on the second output shaft, the third driving mechanism is assembled within the receiving box and connected with the third output shaft thereby driving the third output shaft to rotate.

6. The robot arm assembly of claim 5, wherein the first driving mechanism, the second driving mechanism and the third driving mechanism are located along a peripheral direction of an outer peripheral surface of the hollow tube.

7. The robot arm assembly of claim 1, wherein the assembling hole and the through hole are oppositely defined through two ends of the receiving box, the hollow tube is substantially hollow cylindrical, a first end of the hollow tube is aligned with the through hole of the cover body and is coaxially received within the through hole, and an opposite second end of the hollow tube is coaxially aligned with the opposite assembling hole of the receiving box.

8. The robot arm assembly of claim 2, wherein the receiving box is a substantially hollow rectangular box and comprises a receiving body and a cover body detachably mounted to the receiving body, the assembling hole and the through hole are defined through the receiving body and the cover body.

9. The robot arm assembly of claim 8, wherein the receiving body comprises two parallel first side surfaces, and two second side surfaces, respectively connecting with two adjacent edges of the two first side surfaces; the two first side surfaces and the two second side surfaces cooperatively define a substantially hollow triangular shaped receiving space; the assembling hole is defined through one of the second side surfaces; the cover body has substantially same shape as that of the receiving body, and the cover body and the receiving body cooperatively form the substantially rectangular receiving box and define a substantially rectangular inner receiving space.

10. The robot arm assembly of claim 1, wherein the first output shaft is rotatably assembled with the assembling hole of the receiving box by a rolling bearing.

11. A robot arm assembly comprising:
a receiving box defining an assembling hole and a through hole;
a hollow tube assembled within the receiving box, two ends of the hollow tube aligning with the assembling hole and the through hole, respectively;
a hollow first output shaft rotatably assembled to the receiving box, and being coaxial with the assembling hole of the receiving box, the first output shaft and the hollow tube cooperatively defining a cable passage;
a hollow second output shaft rotatably sleeved on the first output shaft and assembled to the receiving box;
a hollow third out put shaft rotatably sleeved on the second output shaft and assembled to the receiving box; and
three driving mechanisms assembled within the receiving box and respectively connected with the first output shaft, the second out shaft, and the third output shaft, thereby driving the first output shaft, the second out shaft, and the third output shaft to rotate relative to the receiving box.

12. The robot arm assembly of claim 11, wherein the three driving mechanisms are located along a peripheral direction of an outer peripheral surface of the hollow tube.

13. The robot arm assembly of claim 12, wherein the third output shaft is hermetically assembled with assembling hole of the receiving box by a sealing ring.

14. The robot arm assembly of claim 11, wherein each driving mechanism comprises a driving motor, a speed reducer, and a driving gear, the driving gear is assembled within the assembling hole of the receiving box and fixed with corresponding one of the first output shaft, the second output shaft and the third output shaft, the driving motor is fixed within the receiving box and connected with an corresponding driving gear, for driving the driving gear to rotate, and the speed reducer is assembled with the driving motor for controlling a speed of the driving motor.

15. The robot arm assembly of claim 14, wherein the assembling hole and the through hole are oppositely defined through two ends of the receiving box, the hollow tube is substantially hollow cylindrical, a first end of the hollow tube is aligned with the through hole of the cover body and is coaxially received within the through hole, and an opposite second end of the hollow tube is coaxially aligned with the opposite assembling hole of the receiving box.

16. The robot arm assembly of claim 15, wherein the receiving box is a substantially hollow rectangular box and comprises a receiving body and a cover body detachably mounted to the receiving body, the assembling hole and the through hole are respectively defined through the receiving body and the cover body.
